(19) United States
(12) Patent Application Publication
(10) Pub. No.: US 2023/0007598 A1
(43) Pub. Date: Jan. 5, 2023

(54) TRANSMIT POWER OF WIRELESS COMMUNICATION

(71) Applicant: HEWLETT-PACKARD DEVELOPMENT COMPANY, L.P., SPRING, TX (US)

(72) Inventors: KUN-JUNG WU, TAIPEI CITY (TW); HUNG-WEN CHENG, TAIPEI CITY (TW); CHIH-HUNG CHIEN, TAIPEI CITY (TW)

(21) Appl. No.: 17/779,752

(22) PCT Filed: Dec. 20, 2019
(86) PCT No.: PCT/US2019/067922

§ 371 Date: May 25, 2022

(51) Int. Cl. H04W 52/34; H04W 52/36; H04W 52/38

(52) U.S. Cl. CPC H04W 52/346; H04W 52/367; H04W 52/38

(57) ABSTRACT

Approaches for controlling the transmit power of antennas of a communication device, are described. The communication device may include a first wireless communication module and a second wireless communication module. In an example, the first wireless communication module may be coupled to a first antenna.

### BACKGROUND

Wireless communication devices, such as mobile phones, utilize multiple radio access technologies for effecting radio-based communication. The wireless communication devices may include a variety of antennas for receiving as well as for transmitting radio signals while performing different forms of communication activities. The antennas may be further controlled through a corresponding control circuitry provided within the wireless communication device.

### BRIEF DESCRIPTION OF DRAWINGS

The following detailed description references the drawings, wherein:

FIG. 1 illustrates a wireless communication device in which transmit power of a plurality of antennas may be controlled, according to an example of the present subject matter;

FIG. 2 illustrates a wireless communication device in which transmit power of a plurality of antennas may be controlled, according to an example of the present subject matter;

FIG. 3 illustrates a method for controlling transmit power of a plurality of antennas of a wireless communication device, according to an example of the present subject matter;

FIG. 4 illustrates a method for controlling transmit power of a plurality of antennas of a wireless communication device, according to another example of the present subject matter; and

FIG. 5 illustrates a non-transitory computer-readable medium to control the transmit power of a plurality of antennas of a wireless communication device, according to an example of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Wireless communication devices (hereafter referred to as communication devices), such as mobile devices, enable communication services through multiple radio access technologies. Examples of such radio access technologies include, but are not limited to, Bluetooth, Wi-Fi, GSM, UMTS, Long Term Evolution (LTE) and 5G NR. To enable communications through different radio access technologies, the communication device may include different types of antennas for receiving as well as for transmitting radio signals. Depending on the type of radio access technology that is to be used for such communication activities, the appropriate antenna may be activated and controlled through a corresponding control circuitry. For example, the communication device may be used for initiating calls over the telecommunication networks, or in some cases may be used for accessing data through Wi-Fi, for which corresponding cellular antennas or Wi-Fi antennas may be operated.

Advancements in design has resulted in communication devices having thinner form factors. As a result, the antennas of the communication devices may have to be accommodated about the peripheral edges of the communication device, such as near the base portion. In such cases, the antennas may be adjacent to each other. To effect efficient communication, the antennas may operate with a predefined transmit power. Increased transmit power may provide better range for communication, better throughput and data rate, but may increase radio emissions from the communication devices. Thus, in addition to placement of antennas within the communication device, another challenge that may arise relates to adherence to regulatory limits in relation to Specific Absorption Rate (SAR). SAR may be defined as a measure of a rate at which energy is absorbed by the human body on exposure to radio signals. Statutory regulations prescribe limits on the SAR value which is permissible for different types of communication devices. To such an end, the transmit power of the antennas may be limited to conform to SAR limits for the communication device under consideration. In cases where the communication devices include multiple antennas, the transmit power of the multiple antennas may be controlled such that the communication device as a whole conforms to prescribed SAR limits.

In certain instances, a communication device may operate in different modes. In one such mode, the communication device may engage in communication activities pertaining to different radio access technologies, simultaneously. For example, the communication device may be utilizing Wi-Fi as well as a cellular connection when being used as a mobile hotspot. In such cases, the transmit power of the Wi-Fi antenna and the cellular antenna may be controlled such that the communication is efficient, while at the same time conforming to the prescribed SAR limits.

It may be noted that once multiple antennas are operated simultaneously, the transmit power of each of such antennas may have to be reduced for conformance with the SAR limits in comparison to the transmit power of the antennas when they may not have been operating simultaneously. Reducing transmit power may impact the efficiency and quality of communication activities of the communication device when operating in such a mode. Furthermore, in cases where a certain antenna is operational, the antenna may be operated at a predefined transmit power which may be less than a maximum predefined value for the transmit power which the antenna under consideration may operate at, despite the SAR emissions of the communication device being well below the prescribed SAR limits.

Example approaches for controlling the transmit power of plurality of antennas of a communication device, are described. In an example, the communication device may include a first wireless communication module (referred to as a first module) and a second wireless communication module (referred to as second module). The first module may implement communication using a first radio access technology, while the second module may implement communication using a second radio access technology. In an example, the first module may be implementing communication activities at relatively shorter distances as compared to communication activities implemented through the second module, which may occur over larger distances. For instance, the first module may correspond to Wi-Fi based radio access technology and the second module may correspond to a WWAN based radio access technology. It may be noted that the examples thus provided are only indicative and should not be considered as limiting the scope of the present subject matter.

In the present example, the first module and the second module may include control circuitry which control and operate corresponding antennas. In operation, the communication device may determine whether the communication device (referred to as the communication device) is operating in one of a host mode or a client mode. When operating in a host mode, both the first module and the second module may be operational simultaneously. For example, the communication device may be considered as operating in host mode when being used as a mobile hotspot (i.e., in cases where Wi-Fi antenna as well as WWAN antenna are active).

Continuing with the present example, on determining the communication device to be operating in the host mode may reduce the transmit power of the first antenna corresponding to the first module, while maintaining the power of the second antenna corresponding to the second module. Since the first module is to implement communication activities over shorter distances while the second module implements communication activities over larger distances, decreasing the transmit power for the first module while maintaining the transmit power of the second module does not impact the quality of the communication.

In case the communication device is operating in the client mode, i.e., only the first module is operational, the processor may increase the transmit power of the first module to enhance quality of communication. In either case, the transmit power of the first module may be controlled in a manner such that the prescribed SAR limits are conformed with. In an example, the transmit power may be controlled based on a lookup power table which provides predefined values of transmit power for the first module and for the second module.

Although some of the examples provided in the present description have been described in the context of a first module and a second module, it may be apparent that the communication device may have additional wireless communication modules. For example, such additional wireless communication modules may be a set of auxiliary communication modules which supplement communication related functions of the communication device. In other instances, the first module and the second module may operate to supplement the communication functions of the additional wireless communication modules.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

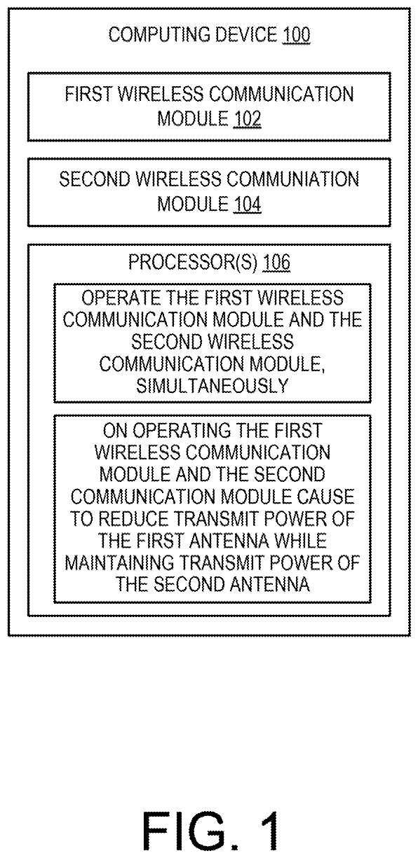

The manner in which the example communication devices are implemented are explained in detail with respect to FIGS. 1-5. While aspects of described communication device may be implemented in any number of different electronic devices, environments, and/or implementations, the examples are described in the context of the following example device(s). It is to be noted that drawings of the present subject matter shown here are for illustrative purposes and are not to be construed as limiting the scope of the subject matter claimed.

FIG. 1 illustrates a communication device 100 (referred to as a communication device 100), according to an example. Examples of communication device 100 includes, but is not limited to, cellular phones, personal computer (PC), notebook PC, workstation or mobile workstation, imaging device, or another type of computing devices, which may be capable of communicating using radio access technologies, such as Bluetooth, Wi-Fi, GSM, UMTS, Long Term Evolution (LTE) or 5G NR.

The communication device 100 may further include a first wireless communication module 102 (referred to as first module 102) and a second wireless communication module 104 (referred to as second module 104). The first module 102 and the second module 104 may include control circuitry and may be further coupled to a first antenna and a second antenna (not shown in FIG. 1), respectively. The first antenna and the second antenna enable communication based on different radio access technologies. In an example, the first antenna may be integrated within circuitry of the communication device 100 such that it is adjacent to the second antenna.

Continuing with the present example, the communication device 100 may further include processor(s) 106 which may be in communication with the first module 102 and the second module 104. The processor(s) 106 may be implemented as microprocessors, microcomputers, microcontrollers, digital signal processors, central processing units, state machines, logic circuitries, and/or any devices that manipulate signals based on operational instructions. Among other capabilities, the processor(s) 106 is configured to fetch and execute the computer-readable instructions stored in a memory (not depicted in FIG. 1), for example, in order to control transmit power of the first antenna and the second antenna.

In operation, the processor(s) 106 may perform a series of functions, for example, in response to execution of executable instructions provided within the communication device 100. For example, the processor(s) 106 may initially operate both the first module 102 and the second module 104 for performing certain communication activities. The activation of the first module 102 and the second module 104 may be in response to the communication device 100 being operated in a mode.

On determining both the first module 102 and the second module 104 to be operating simultaneously, the processor(s) 106 may cause reduction in transmit power of the first antenna corresponding to the first module 102. While the transmit power of the first module 102 is reduced, the transmit power of the second antenna coupled to the second module 104 is maintained. In an example, the first module 102 may be a Wi-Fi based module, whereas the second module 104 may be a WWAN based module. Both the first module 102 and the second module 104 may be operating when the communication device 100 is being used as a wireless hotspot. In the context of the present example, when operating as a wireless hotspot, the antenna corresponding to the Wi-Fi based module (i.e., the first module 102) may be operated at a reduced transmit power while the antenna corresponding to the WWAN based module may be operated at its prescribed transmit power. Since the transmit power of the WWAN is maintained at its prescribed level, the quality of communication activities being performed over the WWAN network is not reduced despite the simultaneous operation of the Wi-Fi module (i.e., the first module 102) and the WWAN module (i.e., the second module 104), while conforming to the prescribed SAR limits.

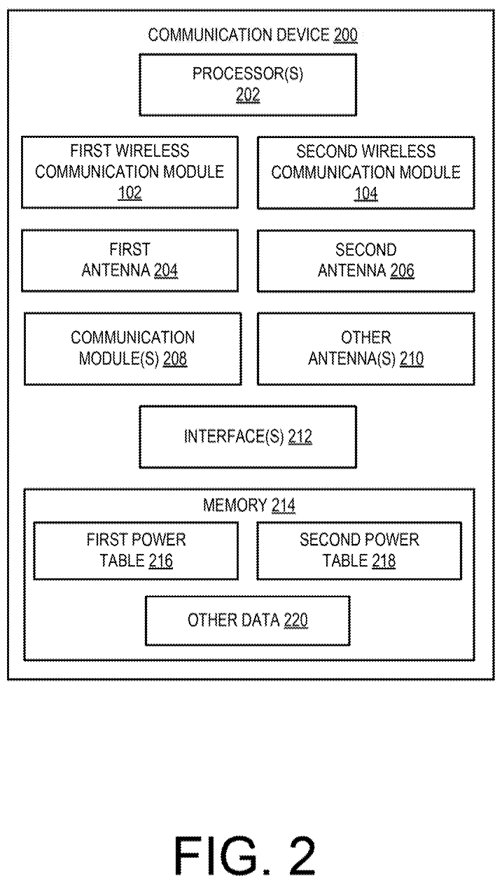

FIG. 2 illustrates a communication device 200, in accordance with an example of the present subject matter. The communication device 200 may include a processor(s) 202, the first module 102 and the second module 104. The first module 102 may be in communication with the first antenna 204, with the second module 104 being in communication with the second antenna 206. In an example, the first module 102 and the second module 104 may further include control circuitry for controlling the transmit power of the first antenna 204 and the second antenna 206, respectively, during the operation of the communication device 200.

Continuing further, the communication device 200 may further include other communication module(s) 208 and corresponding other antenna(s) 210. The first antenna 204, the second antenna 206 along with the other antenna(s) 210 may be utilized for implementing different communication activities using different radio access technologies. Examples of such radio access technologies include, but are not limited to, Bluetooth, Wi-Fi, GSM, UMTS, Long Term Evolution (LTE) or 5G NR. Other technologies which may use radio or any wireless interfaces, may also be considered without deviating from the scope of the present subject matter.

For the purposes of explanation, the first module 102 and the first antenna 204 may be used for implementing Wi-Fi based communication. The second module 104 and the second antenna 206 may be such that they may be used for implementing cellular based radio communication, for example, using Wireless Wide Area Network (WWAN) based network. In such a case, the first module 102 and the first antenna 204 (utilizing Wi-Fi) may implement a variety of communication activities over short distances, for example, over a few meters. On the other hand, the second module 104 and the second antenna 206 (utilizing WWAN) may implement a variety of communication activities over longer distances which may extend over a few kilometres. In a similar manner, the communication module(s) 208 and the other antenna(s) 210 may implement communication activities using other types of radio access technologies. The communication module(s) 208 may also include control circuitry to control the operation of the corresponding other antenna(s) 210.

The communication device 200 may further include interface(s) 212 and memory 214. The interface(s) 212 may allow the connection or coupling of the communication device 200 with other devices, through a wired (e.g., LAN) connection or through a wireless connection (e.g., Bluetooth®, Wi-Fi). The interface(s) 212 may also enable intercommunication between different logical as well as hardware components of the communication device 200. The memory 214 may be implemented as a computer-readable medium, examples of which include volatile memory (e.g., RAM), and/or non-volatile memory (e.g., EPROM, flash memory, etc.). The memory 214 may also be an external memory unit, such as a flash drive, a compact disk drive, an external hard disk drive, or the like.

The memory 214 may further include data which either may be utilized or generated during the operation of the communication device 200. In an example, the memory 214 may include a first power table 216, a second power table 218 and other data 220. The first power table 216 and the second power table 218 may specify various values of transmit power when the communication device 200 is to operate in one of the host mode and the client mode. The values of the transmit power specified in the power table 216 may in turn be such that the communication device 200 conforms with prescribed SAR limits. As will be explained further, the processor(s) 202 is to control the transmit power of first antenna 204, second antenna 206, and the other antenna(s) 210 based on the power table 216, and on determining whether the communication device 200 is operating in one of a host mode and a client mode. The other data 220 on the other hand may include such data which may be utilized or generated by the communication device 200 while performing a variety communication activities.

The communication device 200 may implement a variety of communication activities during its operation. For example, the communication device 200 may initiate calls over a cellular network. To such an end, the second module 104 and the second antenna 206 may be used. In certain other instances, the communication device 200 may be used for accessing data over a Wi-Fi based network, in which case the first module 102 and the first antenna 204 may be used. The communication device 200 may also be used as a mobile or portable hotspot during which both the first antenna 204 and the second antenna 206 may operate simultaneously. As would be understood, when being used as a hotspot, the communication device 200 may utilize the second module 104 and second antenna 206 to connect to the Internet. The Internet connection of the communication device 200 may then be shared with other communication devices (not shown in FIG. 2) through other radio access technologies, such as Wi-Fi, Bluetooth®.

While performing such diverse communication activities, the communication device 200 may operate in a mode in which multiple antennas may be active. In an example, such mode is referred to as a host mode. For example, while operating as a mobile hotspot the first module 102 (which utilizes Wi-Fi for communication) may be simultaneously active along with the second module 104 (which utilizes WWAN or cellular for communication). In cases where multiple antennas may not be operating simultaneously, such a mode may be referred to as a client mode. The communication device 200 may operate in either the host mode or the client mode, which in turn may depend on the communication activities which are to be performed.

In operation, the processor(s) 202 of the communication device 200 may initially determine whether the communication device 200 is to operate in the client mode or the host mode. The processor(s) 202 may determine the mode in response to a user input provided by a user. As discussed in the previous example, when operating in the host mode, the communication device 200 performs diverse communication activities, for example, when being used as a hotspot. In the event that the communication device 200 is to operate in the host mode, the first module 102 (which utilizes Wi-Fi) and the second module 104 (which utilizes WWAN or cellular network) may be operated simultaneously. As discussed, while operating in the host mode, the communication device 200, the communication device 200 may establish a radio communication link over a short distance using the first module 102, simultaneously while establishing another radio communication link over a large distance using the second module 104. In such a case, the processor(s) 202 may control the transmit power of the first module 102 and the corresponding first antenna 204.

In an example, the processor(s) 202 may operate the first antenna 204 at a reduced transmit power. The value of the reduced transmit power at which the first antenna 204 is to be operated, may be obtained based on a reduced value obtained from the first power table 216. In such a case, the processor(s) 202 may generate control instructions for the control circuitry within the first module 102 based on the reduced value. Based on the control instructions from the processor(s) 202, the first module 102 may reduce the transmit power of the first antenna 204. In an example, the reduced transmit power value may be such that it is less than prescribed transmit power of the first module 102 when it is to operate in a normal mode.

While the transmit power of the first antenna 204 is reduced, the processor(s) 202 is to maintain the transmit power of the second antenna 206 at its prescribed level. With the communication device 200 is operating in the host mode (i.e., while being used as a mobile hotspot) since the first module 102, which utilizes Wi-Fi, is to establish communication over shorter distances, operating the first antenna 204 at a reduced transmit power level may not impact the quality of the communication. At the same time, the transmit power of the second antenna 206 may be maintained, thereby ensuring the quality of communication, throughput and data rates with WWAN or the cellular network. In an example, the transmit power of the first antenna 204 may be reduced such that the communication device 200 as a whole conforms with the prescribed SAR limits. This differs from approaches which involved reducing the transmit power of all antennas within a communication device to adhere to the prescribed SAR limits, which may have had an adverse impact while a communication device performs diverse communication activities.

In another example, the communication device 200 may alternately operate in a client mode. When operating in the client mode, the communication modules and the antennas may not operate simultaneously. In such a case, the client mode of the communication device 200 when activated may involve the first module 102 to be operational for performing a certain communication activity. For example, the communication device 200 may access Internet over a Wi-Fi connection. To this end, the communication device 200 may activate the first module 102 (which utilizes Wi-Fi). The processor(s) 202 on determining the communication device 200 to be operating in the client mode, may operate the first antenna 204 at a predefined transmit power. In an example, the processor(s) 202 may obtain a maximum permissible value of transmit power from the second power table 218 for the first antenna 204. Once obtained, the processor(s) 202 may generate control instructions for the first module 102. The first module 102, based on the control instructions, may control the first antenna 204 to operate at the maximum value of the transmit power. In another example, any other value of the transmit power may also be obtained from the power table 216 for operating the first antenna 204.

Although the above examples have been described in the context of the first module 102, the first antenna 204, the second module 104 and the second antenna 206, the same are not to be considered as limiting the scope of the present subject matter. The above-mentioned approaches may be implemented in communication devices, such as the communication device 200, in which additional communication modules, such as communication module(s) 208 and the corresponding other antenna(s) 210 may operate with the first module 102, the second module 104, first antenna 204 and the second antenna 206, for performing communication activities. Examples of such devices may include, but are not limited to, 5G and LTE Advanced based communication devices. Multiple antennas, such as the first antenna 204, second antenna 206 and the other antenna(s) 210 may provide high data rate and enhanced throughout while performing communication activities.

Continuing with the present example, such other communication module(s) 208 may be enabling communication services through radio access technologies which are similar to the radio access technology to which one of the first module 102 and the second module 104 pertain to. For example, a module from amongst the communication module(s) 208 may also enable communication services using Wi-Fi, whereas another module from amongst the communication module(s) 208 may enable communication services through a WWAN or cellular based network. In such cases, certain antennas may be positioned in close proximity with each other when implemented within the communication device 200. For example, first antenna 204 and the second antenna 206 may be located adjacent to each other. The communication device 200 when operated may cause either interference during signal receiving and transmission, or in some other cases may tend to increase the SAR emissions. In such a case, multiple communication modules and their corresponding antennas may be operated either simultaneously or in various combinations to perform communication activities, while ensuring that the device, such as the communication device 200, conforms to the prescribed SAR limits.

In an example, the first module 102 and the second module 104 may be utilized for supplementing the communication module(s) 208. In such a case, the transmit power of the first antenna 204 and the second antenna 206, depending on the mode, may be controlled as per the approaches of the present subject matter, while the transmit power of the other antenna(s) 210 may be controlled either based on the present approaches or based on any other factors, such as proximity of the communication device with a user's body, signal strength, etc. For example, the processor(s) 202 may cause reduction in the transmit power of antennas (such as the first antenna 204 and the like) which pertain to a certain radio access technology while maintaining the transmit power of other antennas (such as the second antenna 206 and the like) which pertain to different radio access technologies. Such other aspects would also fall within the scope of the present subject matter.

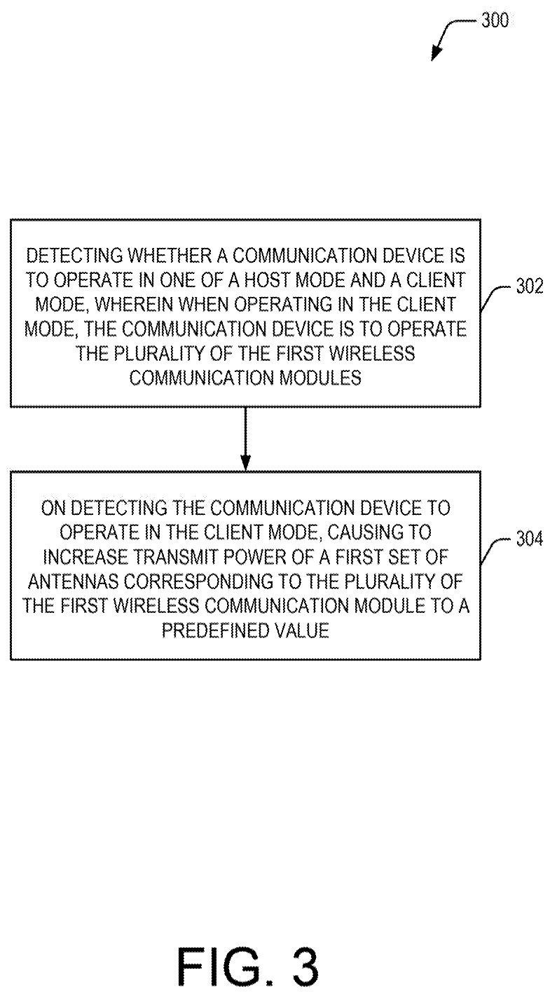

FIG. 3 illustrates a method 300 for controlling transmit power of antennas within a communication device, according to an example of the present subject matter. The order in which the above-mentioned methods are described is not intended to be construed as a limitation, and some of the described method blocks may be combined in a different order to implement the methods, or alternative methods. Although the method 300 may be implemented in a variety of communication devices, for ease of the explanation, the present description of the method 300 is provided in context of the above-described communication device 200. In an example, the method 300 may be implemented by a processor(s), such as the processor(s) 202, through any suitable hardware, non-transitory machine-readable instructions, or combination thereof, where such instructions perform some or all of the steps of the above-mentioned methods.

With reference to FIG. 3, at block 302, whether a communication device is to operate in a client mode, is detected. In an example, the processor(s) 202 of the communication device 200 may initially determine whether the communication device 200 is to operate in the client mode. When operating in the client mode, the communication device 200 may be considered as operating in the client mode, when multiple antennas of the communication device 200 are not operating simultaneously for performing a communication activity. For example, when operating in the client mode, the communication device 200 may involve the first module 102 for performing the communication activity, such as accessing Internet over a Wi-Fi connection.

At block 304, on detecting the communication device to operate in the client mode, transmit power of a first set of antennas from amongst a plurality of antennas corresponding to the plurality of the first wireless communication module is increased to a predefined value. For example, the processor(s) 202 on determining the communication device 200 to be operating in the client mode, may operate the first antenna 204 at a predefined transmit power. In an example, the transmit power may be based on a maximum value of transmit power from the power table 216 for the second antenna 206. Once obtained, the processor(s) 202 may generate control instructions for the first module 102. The first module 102, based on the control instructions, may control the first antenna 204 to operate at the maximum value of the transmit power.

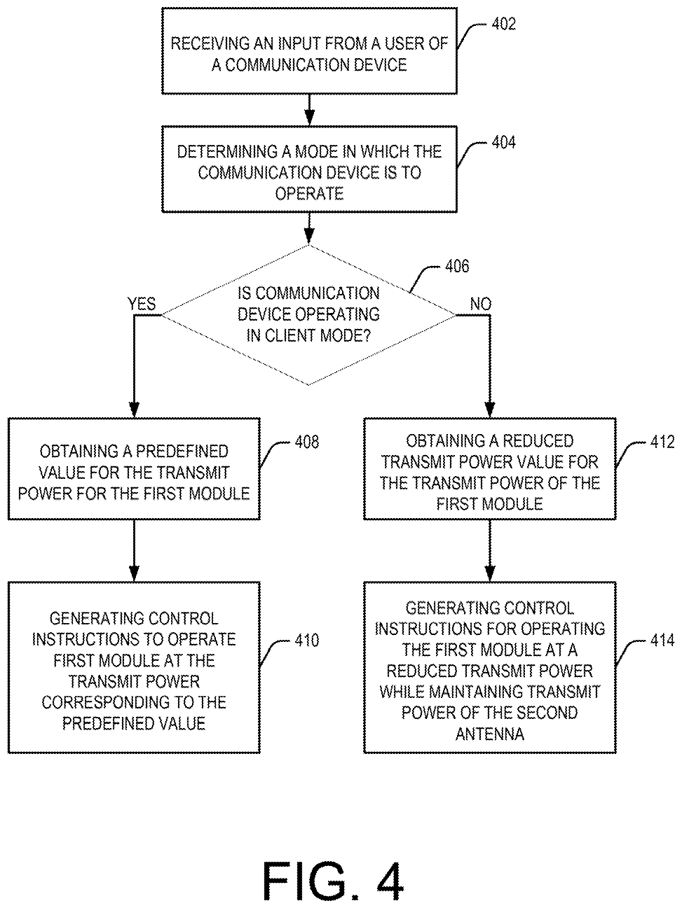

FIG. 4 illustrates another method 400 for controlling transmit power of antennas within a communication device, according to an example of the present subject matter. The order in which the above-mentioned methods are described is not intended to be construed as a limitation, and some of the described method blocks may be combined in a different order to implement the methods, or alternative methods. With reference to FIG. 4, at block 402, an input may be received from a user of a communication device. For example, a user may select an option depending on the communication activities to be performed by the communication device 200.

At block 404, a mode in which the communication device is to operate is determined. For example, based on an input received from a user of the communication device 200, the processor(s) 202 may determine whether the communication device 200 is to operate in a client mode or a host mode. When operating in the client mode, the communication modules and the antennas may not operate simultaneously. In such a case, the communication device 200 operating in a client mode may involve the first module 102 to be operational for performing a certain communication activity, such as accessing Internet over a Wi-Fi connection. On the other hand, the communication device 200 when operating in the host mode may perform diverse communication activities which may involve both the first module 102 and the second module 104 (along with first antenna 204 and second antenna 206) to be operated simultaneously. An example of communication device 200 operating in the host mode includes, but is not limited to, the communication device 200 being used as a mobile hotspot.

At block 406, a further determination is made to ascertain whether the communication device is operating in a client mode. In an example, the processor(s) 202 is to ascertain whether the communication device 200 is operating in the client mode. On determining the communication device 200 to be operating in the client mode (‘Yes’ path from block 406), the processor(s) 202 is to obtain a predefined value for the transmit power for the first module 102 (block 408). In an example, the predefined value may be obtained from the second power table 218. In another example, the processor(s) 202 may be obtain a maximum value of transmit power from the power table 216 which has been prescribed for the second antenna 206.

At block 410, control instructions for operating first module are generated. For example, the processor(s) 202 on obtaining the predefined value of the transmit power, may generate control instructions for the first module 102. Based on the control instructions, the first module 102 controls the first antenna 204 such that it is operated at the predefined transmit power level.

Returning to the present method, on determining the communication device 200 to be operating in the host mode (‘No’ path from block 406), i.e., the first module 102 (which utilizes Wi-Fi) and the second module 104 (which utilizes WWAN or cellular network) are operating, simultaneously, the processor(s) 202 obtains a reduced transmit power value from the power table 216 (block 412). The reduced power level may be a value of the transmit power for operating the first module 102 which may be less than prescribed transmit power when it is to operate in a normal mode.

At block 414, control instructions for operating the first module at a reduced transmit power are generated. For example, the processor(s) 202 on obtaining the reduced transmit power value, may generate control instructions for the first module 102. Based on the control instructions, the first module 102 controls the first antenna 204 such that it is operated at the reduced transmit power level. While the first antenna 204 is operated at a reduced level, the transmit power of the second antenna 206 is maintained and remains unchanged.

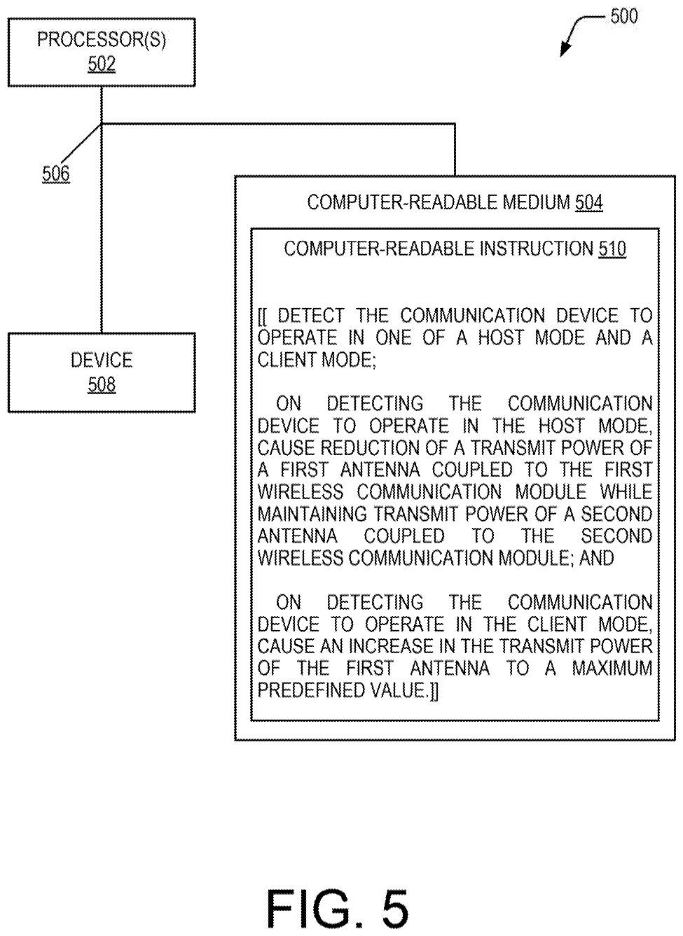

FIG. 5 illustrates a communication environment 500 implementing a non-transitory computer readable medium for controlling the transmit power of multiple antennas of a communication device, such as the communication device 100 and 200. In an example, the communication environment 500 includes processor(s) 502 communicatively coupled to a non-transitory computer readable medium 504 through a communication link 506. In an example implementation, the communication environment 500 may be for a communication environment comprising communication devices 100 and 200 as illustrated in FIGS. 1 and 2. In an example, the processor(s) 502 may include processing resources for fetching and executing computer-readable instructions from the non-transitory computer readable medium 504. The processor(s) 502 and the non-transitory computer readable medium 504 may be implemented, for example, in devices 100 or 200.

The non-transitory computer readable medium 504 may be, for example, an internal memory device or an external memory device. In an example implementation, the communication link 506 may be a network communication link, or other communication links. The processor(s) 502 and the non-transitory computer readable medium 504 may also be communicatively coupled to another device 508 over the network. The device 508 may be implemented, for example, as another communication device or any other processor-based device.

In an example implementation, the non-transitory computer readable medium 504 includes a set of computer readable instructions 510 which may be accessed by the processor(s) 502 through the communication link 506 and subsequently executed to implement the present subject matter. Referring to FIG. 5, in an example, the non-transitory computer readable medium 504 includes instructions 510 that cause the processor(s) 502 to detect whether a communication device, such as the communication device 200, is operating in a host mode or a client mode. A host mode may be considered as a mode in which the communication device 200, when performing communication activities, operates multiple communication modules (i.e., first module 102 and the second module 104), simultaneously. On the other hand, a client mode may be considered as a mode in which the communication device 200 performs communication activities by operating a certain communication module (i.e., the first module 102). In an example, the first module 102 may be Wi-Fi based module, while the second module 104 may be WWAN or cellular communication-based module.

In an example, on determining that the communication device is to operate in host mode, the instructions 510 may cause the processor(s) 502 to reduce the transmit power of a first antenna 204 corresponding to the first module 102, while maintaining the transmit power of the second antenna 206 corresponding to the second module 104. In an example, the value to which the transmit power is reduced may be obtained by the processor(s) 502 from a power table, such as power table 216. It may be noted that since the first module 102, which in the context of the present example is depicted as utilizing Wi-Fi to implement communication over shorter distances, operating the first antenna 204 at a reduced transmit power level does not impact the quality of the communication under consideration.

Furthermore, the instructions 510 may also result in determining that the communication device 200 is to operate in a client mode. When operating in the client mode, the communication modules and the antennas may not operate simultaneously. On determining that the communication device 200 is to operate in the client mode, the instructions 510 may result in increasing transmit power corresponding to the plurality of the first modules to a predefined value. In an example, the instructions 510 may result in increasing the transmit power of the first module 102 (which has been depicted as utilizing Wi-Fi) to a maximum predefined value. The maximum predefined value may be obtained from a repository of transmit power values, such as the second power table 218. In an example, the predefined transmit power at which the first module 102 (and in turn the first antenna 204) is to be operated may be the maximum value prescribed for operating the first antenna 204.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

We claim:

1. A communication device comprising:
a first wireless communication module coupled to a first antenna;
a second wireless communication module coupled to a second antenna;
a processor coupled to the first wireless communication module and second wireless communication module wherein the processor is to:
operate the first wireless communication module and the second wireless communication module, simultaneously; and
on operating the first wireless communication module and the second wireless communication module simultaneously, cause reduction of a transmit power of the first antenna while maintaining a transmit power of the second antenna.

2. The communication device as claimed in claim 1, wherein the first wireless communication module is to cause communication via the first antenna using a first radio access technology, and wherein the second wireless communication module is to cause communication via the second antenna using a second radio access technology.

3. The communication device as claimed in claim 1, wherein, to cause the reduction of the transmit power of the first antenna, the processor is to:
obtain a reduced value to which the transmit power of the first antenna is to be reduced; and
cause the first wireless communication module to generate control instructions to operate the first antenna at the transmit power corresponding to the reduced value.

4. The communication device as claimed in claim 3, wherein the processor is to obtain the reduced value from a power table maintained within the communication device.

5. The communication device as claimed in claim 1, wherein the first antenna is adjacent to the second antenna.

6. A method comprising:
detecting whether a communication device having a plurality of first wireless communication modules and a plurality of second wireless communication modules is to operate in a client mode, wherein in the client mode, the communication device is to operate the plurality of the first wireless communication modules; and
on detecting the communication device operating in the client mode, increasing a transmit power of a first set of antennas from amongst a plurality of antennas corresponding to the plurality of the first wireless communication module to a predefined value.

7. The method as claimed in claim 6, wherein the increasing the transmit power of the first set of antennas comprises:
obtaining the predefined value to which the transmit power of the first set of antenna is to be increased, from a power table; and
generating control instructions to increase the transmit power of the first set of antennas to the predefined value.

8. The method as claimed in claim 6, wherein the predefined value is a maximum permissible power value at which the first set of antennas operate.

9. The method as claimed in claim 6, further comprising:
detecting whether the communication device is operating in a host mode, wherein in the host mode, the communication device is to operate the plurality of first wireless communication modules simultaneously with a plurality of second wireless communication modules; and
on detecting the communication device operating in the host mode, reducing transmit power of the first set of antennas to a reduced transmit power level.

10. The method as claimed in claim 9, further comprising maintaining the transmit power of a second set of antennas corresponding to the second wireless communication module while the transmit power of the first set of antennas is reduced.

11. The method as claimed in claim 9, further comprising generating control instructions based on the reduced transmit power level.

12. A non-transitory computer-readable medium comprising computer-readable instructions, which when executed by a processor, causes a communication device to:
detect the communication device to operate in one of a host mode and a client mode, wherein:
when operating in the host mode, the communication device is to operate a first wireless communication module simultaneously with a second wireless communication module; and
when operating in the client mode, the communication device is to operate the first wireless communication module;
on detecting the communication device to operate in the host mode, cause reduction of a transmit power of a first antenna coupled to the first wireless communication module while maintaining transmit power of a second antenna coupled to the second wireless communication module; and
on detecting the communication device to operate in the client mode, cause an increase in the transmit power of the first antenna to a maximum predefined value.

13. The non-transitory computer-readable medium of claim 12, wherein the reduction in the transmit power of the first antenna is based on a reduced transmit power value.

14. The non-transitory computer-readable medium of claim 13, wherein the reduced transmit power value is obtained from a first power table and the maximum predefined value is obtained from a second power table.

15. The non-transitory computer-readable medium of claim 12, wherein the communication device is to operate as a mobile hotspot when operating in the host mode.
